(19) United States
(12) Patent Application Publication
(10) Pub. No.: US 2022/0203224 A1
(43) Pub. Date: Jun. 30, 2022

(54) Method for Controlling Game Object

(71) Applicant: NETEASE (HANGZHOU) NETWORK CO.,LTD., Hangzhou, Zhejiang (CN)

(72) Inventor: Feng RAO, Hangzhou, Zhejiang (CN)

(21) Appl. No.: 17/606,063

(22) PCT Filed: Mar. 26, 2020
(86) PCT No.: PCT/CN2020/081334

§ 371 Date: Oct. 25, 2021

(30) Foreign Application Priority Data
Apr. 26, 2019 (CN) 201910345210.7

(51) Int. Cl. A63F 13/2145; G06F 3/04883; G06F 3/0482; A63F 13/537

(52) U.S. Cl. CPC A63F 13/2145; A63F 13/537; G06F 3/0482; G06F 3/04883

(57) ABSTRACT

A method for controlling game object is provided. The method includes: in response to grouping trigger operation, providing a grouping control, wherein the grouping control includes at least one grouping sub-control, each of the at least one grouping sub-control corresponds to an object group, and the object group includes at least one game object; in response to first grouping selection operation, determining a first grouping sub-control in the at least one grouping sub-control; and in response to second grouping selection operation, determining a second object group, and combining at least one game object in a first object group corresponding to the first grouping sub-control into the second object group.

### CROSS-REFERENCE TO RELATED APPLICATIONS

The present disclosure claims priority to Chinese Patent Application No. 201910345210.7, filed to the National Intellectual Property Administration on Apr. 26, 2019, and entitled “Method and Apparatus for Controlling Game Object”, the disclosure of which is hereby incorporated by reference in its entirety.

### TECHNICAL FIELD

Embodiments of the disclosure relate to the technical field of games, and more particularly, to a method and apparatus for controlling game object.

### BACKGROUND

With the development of a mobile communication technology, more and more mobile terminal games have emerged. Due to the limitations of hardware conditions and interaction modes, most of the control modes in traditional PC-side games cannot be transplanted to mobile terminal games, so that the mobile terminal games and the traditional PC-side games are greatly different in control modes.

At present, when controlling game objects in mobile terminal games, operating the game objects in a grouping manner can effectively expand the operation mode of the games. However, when adjusting the grouping of game objects in the related art, it is usually necessary to edit the grouping of each game object in sequence. The adjustment of the grouping of game objects cannot be implemented quickly and effectively, resulting in a decrease in the operating efficiency of the games.

### SUMMARY

In a first aspect, an embodiment of the disclosure provides a method for controlling game object, applied to a mobile touch terminal rendered with a graphical user interface. The method includes:

in response to grouping trigger operation, a grouping control is provided, wherein the grouping control includes at least one grouping sub-control, each of the at least one grouping sub-control corresponds to an object group, and the object group includes at least one game object;

in response to first grouping selection operation, a first grouping sub-control is determined in the at least one grouping sub-control; and

in response to second grouping selection operation, a second object group is determined, and at least one game object in a first object group corresponding to the first grouping sub-control is combined into the second object group.

In a possible embodiment, the grouping control is a virtual wheel control, and each of the at least one grouping sub-control is a fan-shaped sub-control of the virtual wheel control.

In a possible embodiment, the grouping trigger operation includes: a touch tapping operation during which a touch tapping duration is greater than a preset duration, or a touch tapping operation under which a touch tapping pressure is greater than a preset pressure.

In a possible embodiment, the first grouping selection operation is a touch sliding operation, and the step that in response to first grouping selection operation, a first grouping sub-control is determined in the at least one grouping sub-control includes:

in response to the first grouping selection operation, the first grouping sub-control is determined in the at least one grouping sub-control according to a sliding trajectory of the first grouping selection operation.

In a possible embodiment, the second grouping selection operation is a touch sliding operation continuous with the first grouping selection operation, and the step that in response to second grouping selection operation, a second object group is determined includes:

in response to the second grouping selection operation, the second object group is determined according to a sliding trajectory of the second grouping selection operation.

In a possible embodiment, the step that in response to second grouping selection operation, a second object group is determined includes:

in response to the second grouping selection operation, a second grouping sub-control is determined in the at least one grouping sub-control, and the second object group is determined in accordance with the second grouping sub-control.

In a possible embodiment, after in response to first grouping selection operation, determining a first grouping sub-control in the at least one grouping sub-control, the method further includes:

at least one grouping sub-control identifier is provided within a preset range of the grouping control, each of the at least one grouping sub-control identifier being used for indicating a grouping sub-control in the at least one grouping control.

The step that in response to second grouping selection operation, a second object group is determined includes:

in response to the second grouping selection operation, a second grouping sub-control identifier is determined in the at least one grouping sub-control identifier, and the second object group is determined in accordance with the second grouping sub-control identifier.

In a possible embodiment, each of the at least one grouping sub-control includes grouping identifier information, and after combining at least one game object in a first object group corresponding to the first grouping sub-control into the second object group, the method includes:

an object identifier of the combined game objects is displayed in a second grouping sub-control; and

a grouping identifier is configured for the combined game objects in the graphical user interface, wherein the grouping identifier is used for indicating a group to which the combined game objects belong.

In a second aspect, an embodiment of the disclosure provides an apparatus for controlling game object, applied to a mobile touch terminal rendered with a graphical user interface. The apparatus includes:

a providing component, configured to in response to grouping trigger operation, provide a grouping control, wherein the grouping control includes at least one grouping sub-control, each of the at least one grouping sub-control corresponds to an object group, and the object group includes at least one game object;

a determination component, configured to in response to first grouping selection operation, determine a first grouping sub-control in the at least one grouping sub-control; and

a combination component, configured to in response to second grouping selection operation, determine a second object group, and combine at least one game object in a first object group corresponding to the first grouping sub-control into the second object group.

In a possible embodiment, the grouping control is a virtual wheel control, and each of the at least one grouping sub-control is a fan-shaped sub-control of the virtual wheel control.

In a possible embodiment, the grouping trigger operation includes: a touch tapping operation during which a touch tapping duration is greater than a preset duration, or a touch tapping operation under which a touch tapping pressure is greater than a preset pressure.

In a possible embodiment, the first grouping selection operation is a touch sliding operation, and the determination component is specifically configured to:

in response to the first grouping selection operation, determine the first grouping sub-control in the at least one grouping sub-control according to a sliding trajectory of the first grouping selection operation.

In a possible embodiment, the second grouping selection operation is a touch sliding operation continuous with the first grouping selection operation, and the combination component is specifically configured to:

in response to the second grouping selection operation, determine the second object group according to a sliding trajectory of the second grouping selection operation.

In a possible embodiment, the combination component is specifically configured to:

in response to the second grouping selection operation, determine a second grouping sub-control in the at least one grouping sub-control, and determine the second object group in accordance with the second grouping sub-control.

In a possible embodiment, the providing component is further configured to:

after determining a first grouping sub-control in the at least one grouping sub-control, provide at least one grouping sub-control identifier within a preset range of the grouping control, each of the at least one grouping sub-control identifier being used for indicating a grouping sub-control in the at least one grouping control.

The combination component is specifically configured to:

in response to the second grouping selection operation, determine a second grouping sub-control identifier in the at least one grouping sub-control identifier, and determine the second object group in accordance with the second grouping sub-control identifier.

In a possible embodiment, each of the at least one grouping sub-control includes grouping identifier information. An identification component is further included.

The identification component is specifically configured to:

after combining at least one game object in a first object group corresponding to the first grouping sub-control into the second object group, display an object identifier of the combined game objects in a second grouping sub-control; and

configure a grouping identifier for the combined game objects in the graphical user interface, wherein the grouping identifier is used for indicating a group to which the combined game objects belong.

In a third aspect, an embodiment of the disclosure provides a device for controlling game object, which includes:

a memory, configured to store at least one executable instruction; and

a processor, connected with the memory, and configured to execute the at least one executable instruction stored in the memory. Wherein the at least one executable instruction includes:

in response to grouping trigger operation, a grouping control is provided, wherein the grouping control includes at least one grouping sub-control, each of the at least one grouping sub-control corresponds to an object group, and the object group includes at least one game object;

in response to first grouping selection operation, a first grouping sub-control is determined in the at least one grouping sub-control; and

in response to second grouping selection operation, a second object group is determined, and at least one game object in a first object group corresponding to the first grouping sub-control is combined into the second object group.

In a fourth aspect, an embodiment of the disclosure provides a non-transitory storage medium, storing a computer program, on which at least one computer program is stored, the at least one computer program being executed by a processor to implement the following steps:

in response to grouping trigger operation, a grouping control is provided, wherein the grouping control includes at least one grouping sub-control, each of the at least one grouping sub-control corresponds to an object group, and the object group includes at least one game object;

in response to first grouping selection operation, a first grouping sub-control is determined in the at least one grouping sub-control; and

in response to second grouping selection operation, a second object group is determined, and at least one game object in a first object group corresponding to the first grouping sub-control is combined into the second object group.

### BRIEF DESCRIPTION OF THE DRAWINGS

In order to more clearly illustrate the technical solutions in the embodiments of the disclosure or the related art, the drawings used in the description of the embodiments or the related art will be briefly described below. It is apparent that the drawings in the following description are some embodiments of the disclosure, and other drawings can be obtained from those skilled in the art according to these drawings without any creative work.

FIG. 1 is a flowchart 1 of a method for controlling game object according to one of the embodiments of the disclosure;

FIG. 2 is a flowchart 2 of a method for controlling game object according to one of the embodiments of the disclosure;

FIG. 3 is a schematic interface diagram 1 of a method for controlling game object according to one of the embodiments of the disclosure;

FIG. 4 is a schematic interface diagram 2 of a method for controlling game object according to one of the embodiments of the disclosure;

FIG. 5 is a schematic interface diagram 3 of a method for controlling game object according to one of the embodiments of the disclosure;

FIG. 6 is a schematic structure diagram 1 of an apparatus for controlling game object according to one of the embodiments of the disclosure;

FIG. 7 is a schematic structure diagram 2 of an apparatus for controlling game object according to one of the embodiments of the disclosure;

FIG. 8 is a schematic hardware structure diagram of a device for controlling game object according to one of the embodiments of the disclosure; and

FIG. 9 is a schematic structure diagram of a non-transitory storage medium according to one of the embodiments of the disclosure.

### DETAILED DESCRIPTION OF THE EMBODIMENTS

In order to make the objectives, technical solutions, and advantages of the embodiments of the disclosure clearer, the technical solutions in the embodiments of the disclosure will be clearly and completely described below with reference to the drawings in the embodiments of the disclosure. It is apparent that the described embodiments are a part of the embodiments of the disclosure, not all of the embodiments. On the basis of the embodiments of the disclosure, all other embodiments obtained on the premise of no creative work of those of ordinary skill in the art should fall within the scope of protection of the disclosure.

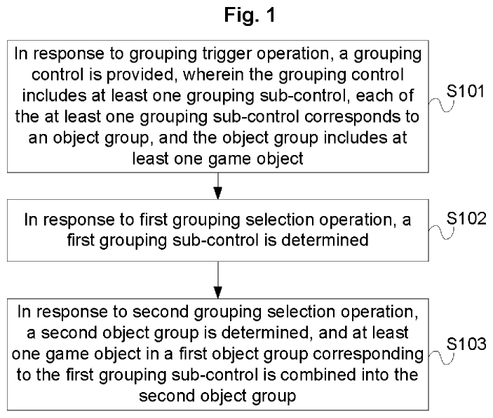

FIG. 1 is a flowchart 1 of a method for controlling game object according to one of the embodiments of the disclosure. As shown in FIG. 1, the method includes the following steps.

In S101, in response to grouping trigger operation, a grouping control is provided. The grouping control includes at least one grouping sub-control, each of the at least one grouping sub-control corresponds to an object group, and the object group includes at least one game object.

Specifically, the present embodiment is applied to a mobile touch terminal rendered with a graphical user interface. The mobile touch terminal refers to a mobile terminal device with a touch-enabled unit (such as a touch screen). Optionally, the mobile terminal device may be a mobile phone (or “cellular” phone), a computer with a wireless communication function, etc. Or, the mobile terminal device may also be portable, pocket-sized, handheld, computer-inbuilt mobile apparatuses or devices, which will not be specially limited.

Further, the graphical user interface refers to a computer operation user interface displayed in a graphical manner, which allows a user to use an input device to manipulate icons or menu controls on a screen of the mobile touch terminal. The input device may be, for example, a touch sensitive pen, or may also be an infrared emitting device, etc., as long as touch operations can be performed. The present embodiment is not limited thereto. During the game, a user operates through the graphical user interface to interact with a client or a server.

Specifically, the present embodiment adjusts the grouping of game objects according to the grouping control, and first responds to the grouping trigger operation to provide the grouping control. In the present embodiment, the grouping control includes at least one grouping sub-control, each of the at least one grouping sub-control corresponds to an object group, and the object group includes at least one game object. For example, there are currently three grouping sub-controls, which correspond to object group 1, object group 2, and object group 3 respectively. Each of the three object groups includes at least one game object.

In an optional implementation manner, the grouping control may be, for example, set as a virtual wheel control, and the corresponding grouping sub-control is a fan-shaped sub-region of the virtual wheel control.

Or, the grouping control may also be, for example, set as a rectangular control including N*M unit rectangles, wherein N and M are positive integers, and the corresponding grouping sub-control is a unit rectangle in the rectangular control. The specific implementation manner of the grouping control in the present embodiment is not limited, and the specific implementation manner may be selected according to actual needs.

In an optional embodiment, the grouping trigger operation is a touch tapping operation. The grouping trigger operation may be a touch tapping operation during which a touch tapping duration is greater than a preset duration, or a touch tapping operation under which a touch tapping pressure is greater than a preset pressure. Both the preset duration and the preset pressure may be set according to actual needs, which is not limited in the present embodiment.

Specifically, the grouping trigger operation is performed at any position of the graphical user interface, and then the touch tapping duration or the touch pressure of the grouping trigger operation is detected. When the touch tapping duration is greater than the preset duration, or the touch tapping pressure is greater than the preset pressure, the grouping control is provided in the graphical user interface, the center position of the grouping control may be located, for example, at the position of a touch point of the grouping trigger operation, or, for example, may also be located at the position that has a mapping relationship with the touch point of the grouping trigger operation. The present embodiment does not limit the position of the grouping control.

In S102, in response to first grouping selection operation, a first grouping sub-control is determined in the at least one grouping sub-control.

In the present embodiment, it is necessary to first determine the grouping of a game object to be adjusted for adjust the grouping of game objects. Specifically, the first grouping sub-control is determined in the at least one grouping sub-control in response to the first grouping selection operation.

The first grouping selection operation may be a touch sliding operation. For example, the center position of the grouping control is used as a start touch point to continue the sliding operation. The first grouping sub-control is determined in the at least one grouping sub-control according to a sliding trajectory of the first grouping selection operation.

In an optional implementation manner, a closed area (for example, a closed area formed by a circular, rectangular or other regular-shaped trajectory, or a closed area formed by other irregular-shaped trajectories) may be determined according to the sliding trajectory, or a closed area may be determined by a non-closed sliding trajectory (for example, the diagonal of a rectangle is determined according to the start and end point of the sliding trajectory, and the rectangle is determined according to a preset aspect ratio, or a diameter is determined according to the start and end point of the sliding trajectory, and a circle is determined according to the diameter), and then the grouping sub-control in the closed area is determined as the first grouping sub-control.

In another optional implementation manner, the touch sliding operation may stop after determining the first grouping sub-control, and the first grouping sub-control may be the grouping sub-control corresponding to the position of the touch end point of the sliding trajectory.

Those skilled in the art can understand that as long as the first grouping sub-control may be determined according to the first grouping selection operation, the specific implementation manner may be selected according to actual needs. For example, the first grouping selection operation may also be a touch tapping operation. The grouping sub-control corresponding to the tapping position of the touch tapping operation is the first grouping sub-control, and the rest of the implementation manners will not be repeated here. The present embodiment does not limit the first grouping selection operation.

In S103, in response to second grouping selection operation, a second object group is determined, and at least one game object in a first object group corresponding to the first grouping sub-control is combined into the second object group.

In the present embodiment, game objects in multiple object groups need to be combined. Therefore, after determining the first object group in accordance with the first grouping sub-control, another second object group to be combined needs to be further determined.

The second object selection operation may be a touch tapping operation, it is determined that the grouping sub-control corresponding to the touch position of the second object selection operation is the second grouping sub-control, and it is determined that the object group contained in the second grouping sub-control is the second object group.

In an optional embodiment, the second object selection operation may also be a touch sliding operation. The touch sliding of the second object selection operation and the sliding trajectory of the touch sliding of the first grouping selection operation form a connection.

In an optional implementation manner, for example, the center area of the grouping control is taken as the touch start point, the first grouping selection operation is first performed to determine the first grouping sub-control according to the sliding trajectory of the first grouping selection operation, and secondly, the touch sliding operation is continued from a touch point where the first group selection operation is currently located, and the touch sliding operation at this time is the second grouping selection operation.

The second grouping sub-control may be directly determined according to the sliding trajectory of the second grouping selection operation. The specific implementation manner is similar to that of determining the first grouping sub-control, and will not be repeated here. Secondly, it is determined that the object group in accordance with the second grouping sub-control is the second object group.

Those skilled in the art can understand that the grouping sub-controls included on a trajectory route of the sliding trajectory formed by the touch sliding operation may be determined as the second grouping sub-control to be combined. If only one second grouped sub-control needs to be selected, it is guaranteed that the trajectory route of the sliding trajectory only includes the first grouping sub-control and a separate second grouping sub-control.

Or, after the first grouping sub-control is determined, a grouping sub-control identifier of at least one grouping control may be provided, and the second grouping sub-control is determined by performing the second grouping selection operation on the grouping sub-control identifier. The second grouping selection operation is also a touch sliding operation continuous with the first grouping selection operation. The present embodiment does not limit the specific implementation manner of the grouping sub-control identifier.

Further, it is determined that the object group in accordance with the second grouping sub-control is the second object group, the at least one game object in the first object group corresponding to the first grouping sub-control is combined into the second object group, and after the combination is completed, the second object group includes at least one game object in the first object group and at least one game object originally in the second object group, but the first game object group no longer includes at least one game object.

The method for controlling game object provided by the embodiment of the disclosure includes: in response to grouping trigger operation, a grouping control is provided, wherein the grouping control includes at least one grouping sub-control, each of the at least one grouping sub-control corresponds to an object group, and the object group includes at least one game object. In response to first grouping selection operation, a first grouping sub-control is determined in the at least one grouping sub-control. In response to second grouping selection operation, a second object group is determined, and at least one game object in a first object group corresponding to the first grouping sub-control is combined into the second object group. The first grouping selection operation and the second grouping selection operation are performed through the grouping control, the first object group and the second object group to be combined are selected, and at least one game object in the first object group is combined into the second object group, thereby realizing quick combination of game objects in different object groups, and improving the operating efficiency of a game.

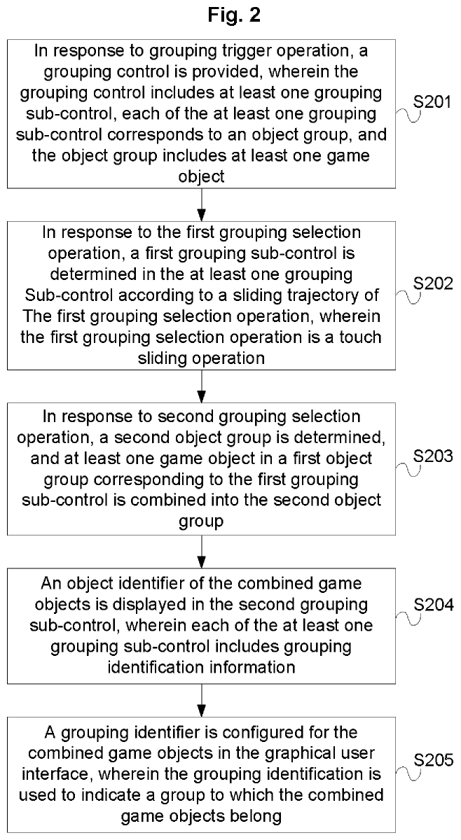

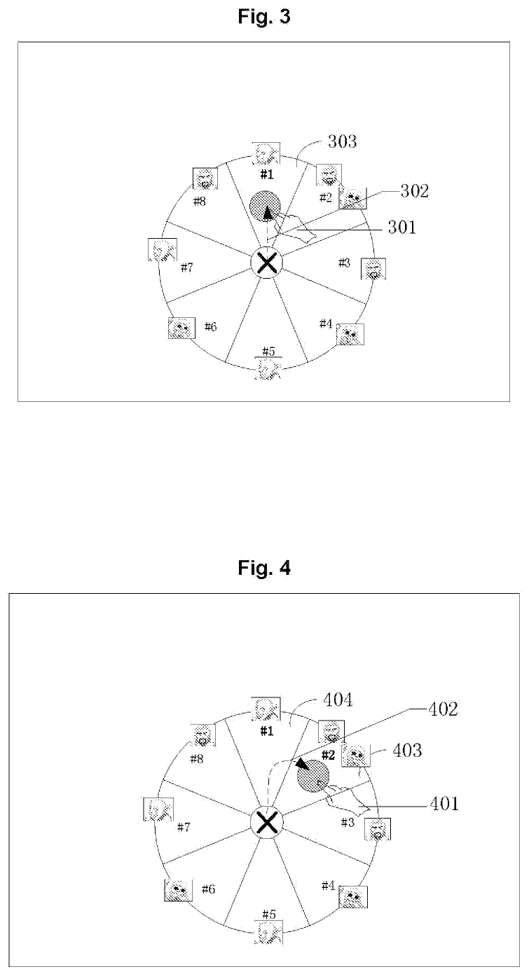

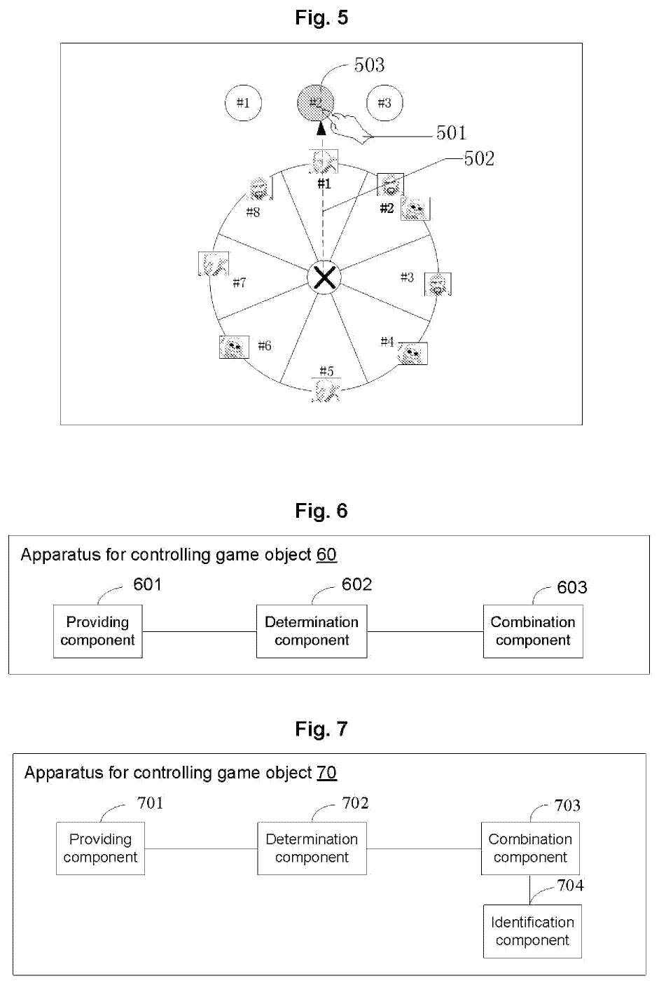

Based on the above embodiments, a method for controlling game object provided by the embodiment of the disclosure will be further described in detail below with reference to FIG. 2 to FIG. 5. FIG. 2 is a flowchart 2 of a method for controlling game object according to one of the embodiments of the disclosure. FIG. 3 is a schematic interface diagram 1 of a method for controlling game object according to one of the embodiments of the disclosure. FIG. 4 is a schematic interface diagram 2 of a method for controlling game object according to one of the embodiments of the disclosure. FIG. 5 is a schematic interface diagram 3 of a method for controlling game object according to one of the embodiments of the disclosure.

As shown in FIG. 2, the method includes the following steps.

In S201, in response to grouping trigger operation, a grouping control is provided, wherein the grouping control includes at least one grouping sub-control, each of the at least one grouping sub-control corresponds to an object group, and the object group includes at least one game object.

Specifically, the implementation manner of step S201 is similar to the step S101, and will not be repeated here.

In S202, in response to the first grouping selection operation, a first grouping sub-control is determined in the at least one grouping sub-control according to a sliding trajectory of the first grouping selection operation, wherein the first grouping selection operation is a touch sliding operation.

In the present embodiment, the first grouping selection operation is a touch sliding operation, which will be described below in conjunction with FIG. 3. As shown in FIG. 3, a grouping control is provided in the graphical user interface. The grouping control is a virtual wheel control. The grouping control includes eight fan-shaped grouping sub-controls, wherein each of the eight grouping sub-control corresponds to an object group, which is respectively identified by numbers 1 to 8. Each object group includes at least one game object.

Specifically, the first grouping selection operation 301, for example, takes the center position of the grouping control as the touch start point, and then pauses or ends in the area of the grouping sub-control corresponding to an object group 1 after the sliding operation, which constitutes a sliding trajectory 302. According to the sliding trajectory of the first grouping selection operation 301, it may be determined that the grouping sub-control corresponding to the object group 1 is the first grouping sub-control 303.

The touch point indicated by the circular shadow in FIG. 3 may be, for example, the touch end point of the sliding touch operation, or it may also be only the touch point passed by the sliding trajectory of the sliding touch operation. The sliding touch operation has not yet ended, and the embodiment does not limit this.

Optionally, in the present embodiment, for example, the first grouping sub-control 303 may be displayed in a preset manner, such as highlight display, special color display, or bold display of group identifiers, so as to quickly determine whether the first grouping sub-control is selected to improve the operating efficiency of the game.

In S203, in response to second grouping selection operation, a second object group is determined, and at least one game object in a first object group corresponding to the first grouping sub-control is combined into the second object group.

In an optional implementation manner, the second grouping selection operation is a touch sliding operation continuous with the first grouping selection operation. The following is an explanation with reference to FIG. 4. After the first grouping sub-control 404 is determined according to the first grouping selection operation that is specifically a touch sliding operation, the second grouping selection operation 401 is performed. The sliding trajectory of the second grouping selection operation 401 and the sliding trajectory of the first grouping selection operation are in a connected state, and, as shown in FIG. 4, form a sliding trajectory 402.

A second grouping sub-control 403 is determined according to the sliding trajectory 402 of the second grouping selection operation 401, thereby determining that the object group in accordance with the second grouping sub-control 403 is the second object group.

In another optional implementation manner, after determining the first grouping sub-control in the at least one grouping sub-control, at least one grouping sub-control identifier is provided within a preset range of the grouping control. Each of the at least one grouping sub-control identifier is used for indicating a grouping sub-control in the grouping control.

The preset range of the grouping control may be, for example, a circular range with the center point or edge point of the grouping control as the center and the preset distance as the radius, or it may also be a giant area with a preset area based on the center point of the preset control, etc. In the present embodiment, there is no restriction on the specific providing position of the grouping sub-control identifier.

Secondly, each of the at least one grouping sub-control identifier may include, for example, the grouping identifier of the object group, or may also include an avatar identifier, a name identifier, etc. of each of the at least one game object contained in the object group. Those skilled in the art can understand that t each of the at least one grouping sub-control identifier corresponds to each of different object groups. There is no restriction on the specific implementation manner here.

In response to the second grouping selection operation, a second grouping sub-control identifier is determined in the at least one grouping sub-control identifier, and the second object group is determined in accordance with the second grouping sub-control identifier.

The following describes with reference to FIG. 5. As shown in FIG. 5, after determining that the grouping sub-control corresponding to object group 1 is the first grouping sub-control, three grouping sub-control identifiers #1, #2 and #3 are provided in the preset range above the grouping control, which are respectively used for indicating the corresponding grouping sub-controls of object groups 1, 2, and 3.

Those skilled in the art can understand that the provided specific grouping sub-control identifier is the identifier of a combinable object group. The combinable object group may be, for example, an object group including at least one game object, or may also be an object group satisfying a preset condition (such as an object group that includes game objects of the same type, or includes a number of game objects less than a preset number, etc.). The implementation manner is similar to that in FIG. 3, and will not be repeated here.

Specifically, the sliding trajectory of the second grouping selection operation 501 and the sliding trajectory of the first grouping selection operation form a connection, which together constitute a sliding trajectory 502, and the grouping sub-control identifier corresponding to #2 is determined as a second grouping sub-control identifier 503 according to the sliding trajectory 502, and the second object group is determined as object group 2 in accordance with the second grouping sub-control identifier 503.

Those skilled in the art can understand that there may be a discontinuity between the touch sliding operation performed by the second grouping selection operation and the first grouping selection operation. For example, after the first grouping selection operation is stopped, the touch end point of the first grouping selection operation is taken as the touch start point of the second grouping selection operation, as long as the second grouping selection operation is a touch sliding operation continuous with the first grouping selection operation, and the specific operation mode may be set according to requirements.

In S204, an object identifier of the combined game objects is displayed in the second grouping sub-control, wherein each of the at least one grouping sub-control includes grouping identifier information.

In the present embodiment, each of the at least one grouping sub-control includes grouping identifier information. The grouping identifier information may be, for example, a grouping number, a grouping name, or a color identifier corresponding to the group, etc., which are used for indicating different object groups.

The object identifier of the game object may be, for example, the graphic or file indication information of the game object (for example, avatar/icon indication information, name indication information), and may also include the number of at least one game object, blood volume of at least one game object, etc. Optionally, the object identifier of the game object may also include content such as text, numbers, letters, or pictures. The present embodiment does not specifically limit the specific implementation manner of the object identifier of the game object.

Specifically, the object identifiers of the combined game objects are displayed in the second grouping sub-control, after the combination operation is completed, the at least one object identifier of at least one game object of the first object group are displayed in the second grouping sub-control, the at least one object identifier of at least one game object of the second object group are also displayed, and the at least one object identifier of the at least one game object are no longer included in the first grouping sub-control at this time.

By displaying an object identifier of a game object, a user can quickly determine game objects included in an object group corresponding to a grouping sub-control, thereby improving the game experience of the user.

In S205, a grouping identifier is configured for the combined game objects in the graphical user interface, wherein the grouping identifier is used for indicating a group to which the combined game objects belong.

In the present embodiment, the grouping identifier may be, for example, a grouping number displayed above the game objects. The grouping number indicates an object group to which the game objects belong, such as group 1 or group 2, or the game objects may be grouped and identified according to a preset color, wherein different colors correspond to different object groups. By using the group identifier on the game objects to indicate the group, the grouping of the game objects can be quickly determined to improve the operating efficiency of the game.

In an optional embodiment, the grouping identifier of game objects may be set to disappear after a preset time has elapsed, or the grouping identifier may also be set to hide. When performing preset operations on the game objects (such as a touch tapping operation or a touch sliding operation), the grouping identifier is displayed again. By setting the preset time, the grouping identifier disappears or hides, which can avoid the confusion of a game interface caused by the long-term existence of the group identifier and interfere with the game operation.

The method for controlling game object provided by the embodiment of the disclosure includes: in response to grouping trigger operation, a grouping control is provided, wherein the grouping control includes at least one grouping sub-control, each of the at least one grouping sub-control corresponds to an object group, and the object group includes at least one game object. The first grouping selection operation is a touch sliding operation. In response to the first grouping selection operation, a first grouping sub-control is determined in each of the at least one grouping sub-control according to a sliding trajectory of the first grouping selection operation. In response to second grouping selection operation, a second object group is determined, and at least one game object in a first object group corresponding to the first grouping sub-control is combined into the second object group. Each of the at least one grouping sub-control includes grouping identifier information. An object identifier of the combined game objects is displayed in the second grouping sub-control. A grouping identifier is configured for the combined game objects in the graphical user interface, wherein the grouping identifier is used for indicating a group to which the combined game objects belong. Through a first object selection operation and a second object selection operation, the combination of game objects in different object groups can be quickly implemented, which improves the operation efficiency of a game. By displaying an identifier of the combined game objects in a grouping sub-control, and by performing a grouping identifier of the combined game objects, a user can quickly determine grouping information of the combined object group, and the game experience of the user can be improved.

FIG. 6 is a schematic structure diagram 1 of an apparatus for controlling game object according to one of the embodiments of the disclosure. As shown in FIG. 6, the apparatus 60 includes: a providing component 601, a determination component 602, and a combination component 603.

The providing component 601 is configured to in response to grouping trigger operation, provide a grouping control, wherein the grouping control includes at least one grouping sub-control, each of the at least one grouping sub-control corresponds to an object group, and the object group includes at least one game object.

The determination component 602 is configured to in response to first grouping selection operation, determine a first grouping sub-control in the at least one grouping sub-control.

The combination component 603 is configured to in response to second grouping selection operation, determine a second object group, and combine at least one game object in a first object group corresponding to the first grouping sub-control into the second object group.

Optionally, the grouping control is a virtual wheel control, and each of the at least one grouping sub-control is a fan-shaped sub-control of the virtual wheel control.

Optionally, the grouping trigger operation includes: a touch tapping operation during which a touch tapping duration is greater than a preset duration, or a touch tapping operation under which a touch tapping pressure is greater than a preset pressure.

Optionally, the first grouping selection operation is a touch sliding operation, and the determination component 602 is specifically configured to:

in response to the first grouping selection operation, determine the first grouping sub-control in the at least one grouping sub-control according to a sliding trajectory of the first grouping selection operation.

Optionally, the second grouping selection operation is a touch sliding operation continuous with the first grouping selection operation, and the combination component 603 is specifically configured to:

in response to the second grouping selection operation, determine the second object group according to a sliding trajectory of the second grouping selection operation.

Optionally, the combination component 603 is specifically configured to:

in response to the second grouping selection operation, determine a second grouping sub-control in the at least one grouping sub-control, and determine the second object group in accordance with the second grouping sub-control.

Optionally, the providing component 601 is further configured to:

after determining a first grouping sub-control in the grouping sub-control, provide at least one grouping sub-control identifier within a preset range of the grouping control, each of the at least one grouping sub-control identifier being used for indicating a grouping sub-control in the grouping control.

The combination component 603 is specifically configured to:

in response to the second grouping selection operation, determine a second grouping sub-control identifier in the at least one grouping sub-control identifier, and determine the second object group in accordance with the second grouping sub-control identifier.

The apparatus provided in the present embodiment may be used to execute the technical solutions of the foregoing method embodiments, and the implementation principles and technical effects are similar. The present embodiment will not be described here.

FIG. 7 is a schematic structure diagram 2 of an apparatus for controlling game object according to one of the embodiments of the disclosure. As shown in FIG. 7, on the basis of the embodiment of FIG. 6, in the present embodiment, each of the at least one grouping sub-control includes grouping identifier information, and the apparatus further includes an identification component 704.

Optionally, the identification component 704 is specifically configured to:

after combining at least one game object in a first object group corresponding to the first grouping sub-control into the second object group, display an object identifier of the combined game objects in a second grouping sub-control; and

configure a grouping identifier for the combined game objects in the graphical user interface, wherein the grouping identifier is used for indicating a group to which the combined game objects belong.

The apparatus provided in the present embodiment may be used to execute the technical solutions of the foregoing method embodiments, and the implementation principles and technical effects are similar. The present embodiment will not be described here.

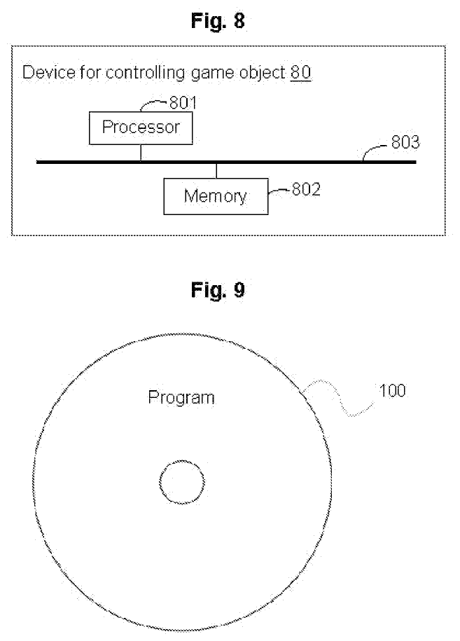

FIG. 8 is a schematic hardware structure diagram of a device for controlling game object according to one of the embodiments of the disclosure. As shown in FIG. 8, a device 80 for controlling game object of the present embodiment includes: a processor 801 and a memory 802.

The memory 802 is configured to store at least one executable instruction.

The processor 801 is connected with the memory, and configured to execute the at least one executable instruction stored in the memory 802, wherein the at least one executable instruction includes:

in response to grouping trigger operation, a grouping control is provided, wherein the grouping control includes at least one grouping sub-control, each of the at least one grouping sub-control corresponds to an object group, and the object group includes at least one game object;

in response to first grouping selection operation, a first grouping sub-control is determined in the at least one grouping sub-control; and

in response to second grouping selection operation, a second object group is determined, and at least one game object in a first object group corresponding to the first grouping sub-control is combined into the second object group.

The processor 801 may execute various functional applications and data processing by running software programs and modules stored in the memory 802 to implement various steps performed by the method for controlling game object in the above embodiments. For details, reference may be made to the related description in the foregoing method embodiments.

Optionally, the memory 802 may be independent or integrated with the processor 801.

When the memory 802 is independently arranged, the device for controlling game object further includes a bus 803 configured to connect the memory 802 and the processor 801.

An embodiment of the disclosure also provides a non-transitory storage medium that stores a computer-executable instruction. When a processor executes the computer-executable instruction, the method for controlling game object performed by the device for controlling game object is implemented.

FIG. 9 is a schematic structure diagram of a non-transitory storage medium according to one of the embodiments of the disclosure. As shown in FIG. 9, a program product 100 according to an implementation manner of the disclosure is described. The non-transitory storage medium stores a computer program, on which at least one computer program is stored, the at least one computer program being executed by a processor to implement the following steps:

in response to grouping trigger operation, a grouping control is provided, wherein the grouping control includes at least one grouping sub-control, each of the at least one grouping sub-control corresponds to an object group, and the object group includes at least one game object;

in the grouping sub-control in response to first grouping selection operation, a first grouping sub-control is determined; and

in response to second grouping selection operation, a second object group is determined, and at least one game object in a first object group corresponding to the first grouping sub-control is combined into the second object group.

Optionally, in the present embodiment, the non-transitory storage medium may also be configured as a program code for determining various preferred or optional method steps of the method for controlling game object.

The various functional components provided by the embodiments of the disclosure may be run in an apparatus for controlling game object or a similar operational apparatus, or may be stored as part of the storage medium.

Those of ordinary skill in the art can understand that all or part of the steps in various methods of the above embodiments may be completed by a program to instruct the related hardware of the apparatus for controlling game object. The program may be stored in a non-transitory storage medium of the apparatus for controlling game object. The computer storage medium may include a flash disk, a Read-Only Memory (ROM), a Random Access Memory (RAM), a magnetic disk or an optical disk, and the like.

In some embodiments provided by the disclosure, it is to be understood that the disclosed device and method may be implemented in another manner. For example, the device embodiment described above is only schematic, and for example, division of the components is only logic function division, and other division manners may be adopted during practical implementation. For example, multiple components may be combined or integrated into another system, or some characteristics may be neglected or not executed. In addition, coupling or direct coupling or communication connection between each displayed or discussed component may be indirect coupling or communication connection, implemented through some interfaces, of the device or the components, and may be electrical and mechanical or adopt other forms.

The integrated component implemented in the form of a software functional component may be stored in a non-transitory storage medium. The software functional component is stored in a storage medium, including a plurality of instructions enabling a computer device (which may be a personal computer, a server, a network device or the like) or a processor to execute part of the steps of the method in each embodiment of the disclosure.

It should be understood that the processor may be a Central Processing Unit (CPU), or may be other general purpose processors, a Digital Signal Processor (DSP), an Application Specific Integrated Circuit (ASIC), or the like. The general purpose processor may be a microprocessor, or the processor may also be any conventional processor, etc. The steps of the method disclosed in combination with the disclosure may be directly embodied as a hardware processor for execution and completion, or a combination of hardware and software components in the processor for execution and completion.

The memory may include a high-speed RAM, may also include a Non-Volatile Memory (NVM) such as at least one magnetic disk memory, and may also be a U disk, a mobile hard disk, a ROM, a magnetic disk, or an optical disk.

The bus may be an Industry Standard Architecture (ISA) bus, a Peripheral Component (PCI) bus, or an Extended Industry Standard Architecture (EISA) bus. The bus may be divided into an address bus, a data bus, a control bus, and the like. For ease of representation, the bus in the drawings of the disclosure does not limit to only one bus or one type of bus.

The above storage medium may be implemented by any type of volatile or non-volatile storage device or a combination thereof, such as a Static Random Access Memory (SRAM), an Electrically Erasable Programmable Read Only Memory (EEPROM), an Erasable Programmable Read Only Memory (EPROM), a Programmable Read Only Memory (PROM), a ROM, a magnetic memory, a flash memory, a magnetic disk or an optical disk. The storage medium may be any available medium that can be accessed by a general purpose or special purpose computer.

Those of ordinary skill in the art may understand that all or part of the steps of the foregoing method embodiments may be completed by a program instructing relevant hardware. The foregoing program may be stored in a non-transitory storage medium. When the program is executed, the steps including the foregoing method embodiments are performed. The foregoing storage medium includes various media capable of store program codes, such as a ROM, a RAM, a magnetic disk, or an optical disk.

Finally, it is to be noted that the above embodiments are only used to illustrate the technical solutions of the disclosure, and are not limited thereto. Although the disclosure has been described in detail with reference to the foregoing embodiments, those skilled in the art should understand that the technical solutions described in the foregoing embodiments are modified, or some or all technical features are equivalently replaced, but the modifications and replacements do not make the essence of the corresponding technical solutions depart from the scope of the technical solutions of various embodiments of the disclosure.

It is to be noted that the specification and claims of the disclosure and the terms “first”, “second” and the like in the drawings are used to distinguish similar objects, and do not need to describe a specific sequence or a precedence order. It will be appreciated that data used in such a way may be exchanged under appropriate conditions, in order that the embodiments of the disclosure described here can be implemented in a sequence other than sequences graphically shown or described here. In addition, terms “include” and “have” and any variations thereof are intended to cover non-exclusive inclusions. For example, it is not limited for processes, methods, systems, products or devices containing a series of steps or components to clearly list those steps or components, and other steps or components which are not clearly listed or are inherent to these processes, methods, products or devices may be included instead.

It is to be finally noted that the steps shown in the flowchart of the drawings may be executed in a computer system including, for example, a set of computer-executable instructions. Moreover, although a logic sequence is shown in the flowchart, the shown or described steps may be executed in a sequence different from the sequence here under certain conditions.

### INDUSTRIAL APPLICABILITY

In response to grouping trigger operation, a grouping control is provided, wherein the grouping control includes at least one grouping sub-control, each of the at least one grouping sub-control corresponds to an object group, and the object group includes at least one game object. The first grouping selection operation is a touch sliding operation. In response to the first grouping selection operation, a first grouping sub-control is determined in the at least one grouping sub-control according to a sliding trajectory of the first grouping selection operation. In response to second grouping selection operation, a second object group is determined, and at least one game object in a first object group corresponding to the first grouping sub-control is combined into the second object group. Each of the at least one grouping sub-control includes grouping identifier information. An object identifier of the combined game objects is displayed in a second grouping sub-control. A grouping identifier is configured for the combined game objects in the graphical user interface, wherein the grouping identifier is used for indicating a group to which the combined game objects belong. Through a first object selection operation and a second object selection operation, the combination of game objects in different object groups can be quickly implemented, which improves the operation efficiency of a game. By displaying an identifier of the combined game objects in a grouping sub-control, and by performing a grouping identifier of the combined game objects, a user can quickly determine grouping information of the combined object group, and the game experience of the user can be improved, so as to overcome the problem that the grouping adjustment of game objects cannot be implemented quickly and effectively.

What is claimed is:

1. A method for controlling game object, applied to a mobile touch terminal rendered with a graphical user interface, comprising:
in response to grouping trigger operation, providing a grouping control, wherein the grouping control comprises at least one grouping sub-control, each of the at least one grouping sub-control corresponds to an object group, and the object group comprises at least one game object;
in response to first grouping selection operation, determining a first grouping sub-control in the at least one grouping sub-control; and
in response to second grouping selection operation, determining a second object group, and combining at least one game object in a first object group corresponding to the first grouping sub-control into the second object group.

2. The method as claimed in claim 1, wherein the grouping control is a virtual wheel control, and each of the at least one grouping sub-control is a fan-shaped sub-control of the virtual wheel control.

3. The method as claimed in claim 1, wherein the grouping trigger operation comprises: a touch tapping operation during which a touch tapping duration is greater than a preset duration, or a touch tapping operation under which a touch tapping pressure is greater than a preset pressure.

4. The method as claimed in claim 1, wherein the first grouping selection operation is a touch sliding operation, and in response to first grouping selection operation, determining a first grouping sub-control in the at least one grouping sub-control comprises:
in response to the first grouping selection operation, determining the first grouping sub-control in the at least one grouping sub-control according to a sliding trajectory of the first grouping selection operation.

5. The method as claimed in claim 1, wherein the second grouping selection operation is a touch sliding operation continuous with the first grouping selection operation, and in response to second grouping selection operation, determining a second object group comprises:
in response to the second grouping selection operation, determining the second object group according to a sliding trajectory of the second grouping selection operation.

6. The method as claimed in claim 1, wherein in response to second grouping selection operation, determining a second object group comprises:
in response to the second grouping selection operation, determining a second grouping sub-control in the at least one grouping sub-control, and determining the second object group in accordance with the second grouping sub-control.

7. The method as claimed in claim 1, wherein after in response to first grouping selection operation, determining a first grouping sub-control in the grouping sub-control, the method further comprises:
providing at least one grouping sub-control identifier within a preset range of the grouping control, each of the at least one grouping sub-control identifier being used for indicating a grouping sub-control in the grouping control; and
in response to second grouping selection operation, determining a second object group comprises:
in response to the second grouping selection operation, determining a second grouping sub-control identifier in the at least one grouping sub-control identifier, and determining the second object group in accordance with the second grouping sub-control identifier.

8. The method as claimed in claim 1, wherein each of the at least one grouping sub-control comprises grouping identifier information, and after combining at least one game object in a first object group corresponding to the first grouping sub-control into the second object group, the method comprises:
displaying an object identifier of the combined game objects in a second grouping sub-control; and
configuring a grouping identifier for the combined game objects in the graphical user interface, wherein the grouping identifier is used for indicating a group to which the combined game objects belong.

9. (canceled)

10. A device for controlling game object, comprising:
a memory, configured to store at least one executable instruction; and
a processor, connected with the memory, and configured to execute the at least one executable instruction stored in the memory, wherein the at least one executable instruction comprises:
in response to grouping trigger operation, providing a grouping control, wherein the grouping control comprises at least one grouping sub-control, each of the at least one grouping sub-control corresponds to an object group, and the object group comprises at least one game object;
in response to first grouping selection operation, determining a first grouping sub-control in the at least one grouping sub-control; and
in response to second grouping selection operation, determining a second object group, and combining at least one game object in a first object group corresponding to the first grouping sub-control into the second object group.

11. A non-transitory storage medium, storing a computer program, on which at least one computer program is stored, the at least one computer program being executed by a processor to implement the following steps:
in response to grouping trigger operation, providing a grouping control, wherein the grouping control comprises at least one grouping sub-control, each of the at least one grouping sub-control corresponds to an object group, and the object group comprises at least one game object;
in response to first grouping selection operation, determining a first grouping sub-control in the at least one grouping sub-control; and
in response to second grouping selection operation, determining a second object group, and combining at least one game object in a first object group corresponding to the first grouping sub-control into the second object group.

12. The method as claimed in claim 1, wherein the grouping control is a rectangular control, and each of the at least one grouping sub-control is a unit rectangle of the rectangular control.

13. The method as claimed in claim 1, wherein the center position of the grouping control is located at the position of a touch point of the grouping trigger operation, or, at the position that has a mapping relationship with the touch point of the grouping trigger operation.

14. The method as claimed in claim 4, wherein the first grouping sub-control is the grouping sub-control in a closed area that is determined according to the sliding trajectory.

15. The method as claimed in claim 4, wherein the first grouping sub-control is the grouping sub-control corresponding to the position of the touch end point of the sliding trajectory.

16. The method as claimed in claim 5, wherein the center area of the grouping control is taken as the touch start point of the first grouping selection operation, and the touch end point of the first grouping selection operation is taken as the touch start point of the second grouping selection operation.

17. The method as claimed in claim 6, wherein the second grouping selection operation is a touch tapping operation, and the second grouping sub-control is the grouping sub-control corresponding to the touch position of the second object selection operation.

18. The method as claimed in claim 7, wherein the preset range of the grouping control is a circular range with the center point or edge point of the grouping control as the center and the preset distance as the radius, or a giant area with a preset area based on the center point of the preset control.

19. The method as claimed in claim 8, wherein the combined game objects are grouped and identified according to a preset color, wherein different colors correspond to different object groups.

20. The method as claimed in claim 8, wherein the grouping identifier on the combined game objects is set to disappear after a preset time has elapsed, or set to hide.

21. The method as claimed in claim 1, wherein the first grouping sub-control is displayed in a preset manner.
